(19) United States
(12) Patent Application Publication
(10) Pub. No.: US 2010/0050488 A1
(43) Pub. Date: Mar. 4, 2010

(54) SIGNAGE SYSTEM

(75) Inventors: Martijn Krans, Eindhoven (NL); Anthonie Hendrik Bergman, Eindhoven (NL); Bartel Marinus Van De Sluis, Eindhoven (NL); Erich Zainzinger, Hong Kong (CN); Wouter Bastiaan Zeper, Eindhoven (NL); Guido Theo Maria Lamerichs, Leuven (BE); Thomas Schuler, Leuven (BE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/525,915

(22) PCT Filed: Feb. 5, 2008
(86) PCT No.: PCT/IB08/50408

§ 371 Date: Aug. 5, 2009

(30) Foreign Application Priority Data
Feb. 12, 2007 (EP) 07102143.0

(51) Int. Cl. G09F 13/00; G09F 7/00; G09F 21/02

(52) U.S. Cl. 40/541; 40/584; 40/586

(57) ABSTRACT

The present invention relates to a signage system (10) comprising a plurality of textile products (12), wherein each textile product comprises a flexible display device (14) adapted to show a display content forming part of a unified message. The system is characterized in that each flexible display device (14) further is adapted to show an indication of the position of the display content of the flexible display device in relation to the display contents of the other flexible display devices in the unified message, before showing the display content. The present invention also relates to a method for presenting a unified message by means of a plurality of flexible display devices (14) each comprised in a textile product (12).

### FIELD OF THE INVENTION

The present invention relates to a signage system comprising a plurality of textile products, each of which comprises a flexible display device adapted to show a display content forming part of a unified message. The present invention also relates to a method for presenting a unified message by means of a plurality of flexible display devices each comprised in a textile product.

### BACKGROUND OF THE INVENTION

An example of a textile product comprising a flexible display device is disclosed in WO2006/014230. More precisely, WO2006/014230 describes a flexible display screen with a plurality of light emitting diodes acting as pixels in a matrix pattern. The display is installed in a jacket. The display may for instance be held by a pocket or pouch in proximity to the outer cloth of the jacket, which pocket or pouch resides inside the lining of the jacket. The display is controlled by a control circuit connected to it, and the system is powered by a battery pack. Both the control circuit and battery pack may also be placed within the jacket. Upon operation, light from the display is transmitted through the outer cloth so that an illuminated message, for instance a word, may be shown “on” the jacket. Such a jacket can be used at events for promotion or marketing purposes, as personal protective clothing of highway and railroad workers, or police, fire and ambulance crews, etc.

It may be desirable to use a plurality of such displays nearby each other to show a larger message. To this end, WO2006/014230 discloses an example set in a sports arena where individual members of the crowd represent smaller area screens and the crowd collectively make up a large area screen. Here, each individual may dial up a telephone number by means of a wireless phone and input the seating or standing area they are located in. An Internet linked computer server communicating with each individual phone can then compute the appropriate data to send to each wireless phone. Each phone can then relay the data through a wired interface to the individuals' small screen or through a wireless interface such as Bluetooth.

However, the solution in WO2006/014230 for providing a larger, unified message, as well as other known solutions, may be expensive to implement due to the additional technical peripheral equipment involved. Also, the solution requires the users to perform several relatively complex steps, which may hamper the degree of utility. Furthermore, not every user may be equipped with the necessary wireless phone.

### SUMMARY OF THE INVENTION

It is an object of the present invention to overcome these problems, and to provide an improved, more simple signage system for providing a unified message.

This and other objects that will be apparent from the following description are achieved by means of a signage system, and a method for presenting a unified message, according to the appended claims.

According to a first aspect, there is provided a signage system comprising a plurality of textile products, wherein each textile product comprises a flexible display device adapted to show a display content forming part of a unified message, characterized in that each flexible display device further is adapted to show an indication of the position of the display content of the flexible display device in relation to the display contents of the other flexible display devices in the unified message, before showing said display content.

The invention is based on the understanding that the initial showing of an indication of the display content's intended position in relation to other display contents with respect to the unified message allows the displays to be sorted correctly before the actual display contents are shown.

Preferably, the indication is an indication of an element of a sequential order, wherein for each flexible display device the element's position in the sequential order corresponds to the position of the flexible display device's display content in the unified messaged. For instance, to present the unified message “PHILIPS”, one display may be adapted to show the display content “P”, another one may be adapted to show “H”, a third shows “I”, and so on. Before these letters are shown, each display first shows an indication of an element of a sequential order, which element's position corresponds to display content's position in the unified message. The sequential order may be a sequence of characters or numbers, such as “1-2-3-4- . . . ” or “A-B-C-D- . . . ”, for easy and intuitive recognition. Thus, the display adapted to show “P” may initially indicate “1”, the display adapted to show “H” may initially show “2”, the display adapted to show “I” may initially show “3”, and so one. During this initial showing, the displays may be arranged according to the order of the sequence, in this case 1-2-3-4-5-6-7, so that when the real message is presented on all displays, which preferably happens automatically, “P-H-I-L-I-P-S” is spelled out correctly.

In one embodiment, at least one of the textile products further comprises an alert mechanism, such as a buzzer or vibrating device, adapted to be actuated during the showing of the indication to alert a wearer of the textile product of the showing of the indication, so that the wearer can notice the indication in order to sort the displays correctly. Since the wearer is notified in this way, the initial showing of the indication can be very brief.

In an envisaged embodiment, the textile products are garments, such as shirts, which can be used as promotion or stage or security wear to present a unified message. When the indications are shown, preferably during a relatively short start-up time, persons wearing the shirts can easily arrange themselves into the right order. No other visual markings on the displays are necessary, and the indication and related display content may be preprogrammed into each display.

The flexible display device is preferably a light emitting diode (LED) based display. Such an LED display can be made relatively thin and flexible, and is power efficient, which is especially beneficial when used in a shirt.

According to another aspect, there is provided a method for presenting a unified message by means of a plurality of flexible display devices each comprised in a textile product, comprising: providing each flexible display device with a display content forming part of the unified message and an indication of the position of the display content of the flexible display device in relation to the display contents of the other flexible display devices in the unified message; show the indications on the flexible display devices, allowing the flexible display devices to be arranged in accordance with the shown indications; and show the display contents on the flexible display devices. This aspect exhibits similar advantages as the previously discussed aspect of the invention.

### BRIEF DESCRIPTION OF THE DRAWINGS

These and other aspects of the present invention will now be described in more detail, with reference to the appended drawings showing a currently preferred embodiment of the invention.

FIGS. 1a-1d schematically show a signage system according to the invention.

### DETAILED DESCRIPTION

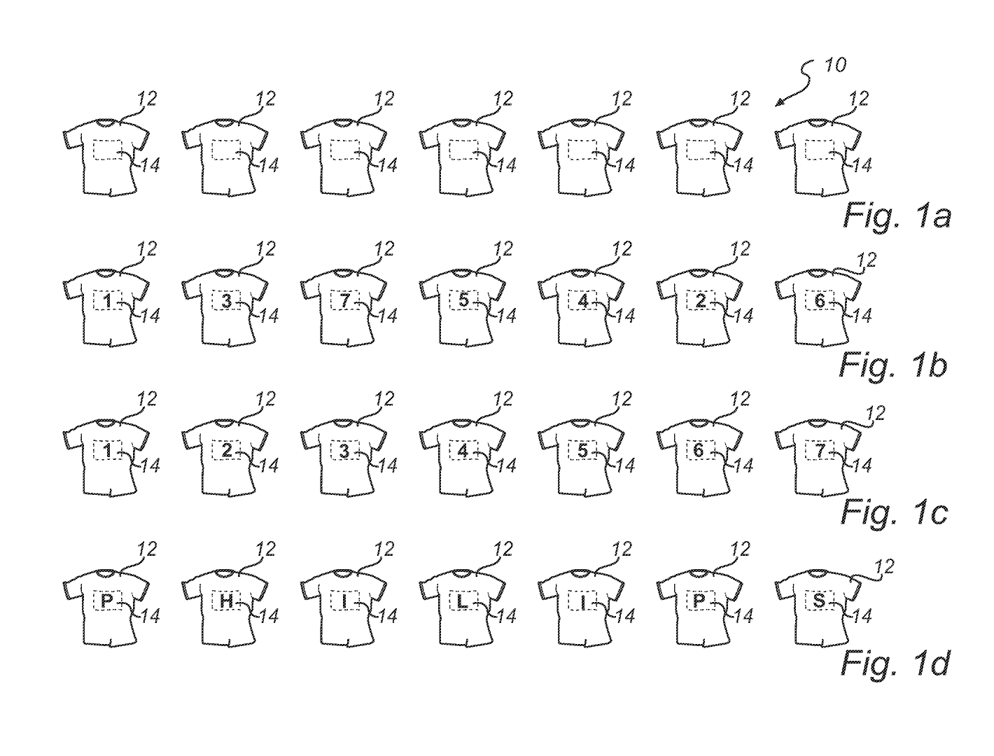

FIGS. 1a-1d schematically show a signage system 10 according to the invention. The signage system 10 comprises a plurality of textile products 12. The textile products 12 in FIGS. 1a-1d are garments, more precisely shirts. Alternatively, the textile products may be other garments, such as jackets or vests, or furniture, bags, cushions, etc.

Each shirt comprises a flexible display device 14 (in the following “display” 14). The display 14 is installed behind the outer cloth of the shirt 12. Preferably, the display 14 comprises a plurality of light emitting diodes (LEDs) mounted on a flexible substrate (not shown). When the display 14 is on, an illuminated image or animation or other message may be shown through the outer cloth on the shirt 12. On the other hand, when the display 14 is off, the display 14 is hardly visible from outside the shirt 12.

Each display 14 may be adapted to show a display contents such as a letter, word, image, animation, etc. forming part of a unified message to be shown by several displays. In FIGS. 1a-1d, each display 14 is adapted to show one of the letters of the word “PHILIPS”, which word thus constitutes the unified message to be displayed. To this end, when the unified message is to be presented, the shirts 12 are preferably arranged nearby each other. The specific letter to be shown may be programmed into each display 14 before use.

According to an embodiment of the invention, before showing the actual, unified message, each display 14 is further adapted to show a specific number for a relatively short start-up period, such as 10-20 seconds. In this case (seven shirts), the numbers 1-2-3-4-5-6-7 may be used. The number's position in the order 1-2-3-4-5-6-7 should correspond to the position of the display's letter in the unified message, which in this case means that “P” corresponds to “1”, “H” corresponds to “2”, “I” corresponds to “3”, “L” corresponds to “4”, “I” corresponds to “5”, “P” corresponds to “6”, and “S” corresponds to “7”. Thus, the display adapted to show “P” initially shows “1”, the display adapted to show “H” initially shows “2”, the display adapted to show “I” initially shows “3”, and so one. The specific number to be shown may be programmed into each display 14 before use.

In FIG. 1a, all displays 14 are at first turned off. In this state, there is no visual indication as to which display is which. In FIG. 1b, the displays 14 are turned on, and each display 14 show a specific number as described above. During the time these numbers are shown, persons wearing the shirts can easily arrange themselves into the right order, in this case 1-2-3-4-5-6-7 (FIG. 1c). Then, the displays 14 switch to show the real message. Since the displays 14 already have been sorted according to the sequence 1-2-3-4-5-6-7 in FIG. 1c, the word “P-H-I-L-I-P-S” is immediately spelled out correctly as a unified message in FIG. 1d.

In a further embodiment, the shirts may be equipped with an alert mechanism (not shown), such as a buzzer or vibrating device, which is actuated during the initial showing of the positional indication (the numbers 1-7 in the above example) to alert the user that the positional or sorting indication is displayed, so that the wearer can notice the indication in order to sort the displays correctly.

The person skilled in the art realizes that the present invention by no means is limited to the preferred embodiments described above. On the contrary, many modifications and variations are possible within the scope of the appended claims. For instance, for three displays, instead of 1-2-3 as above, the displays may initially show the indications “left”-“middle”-“right”, respectively, before displaying the actual message, allowing the displays to be sorted correctly so that the unified message immediately is presented properly. Further, in the case of a unified message formed by a grid or matrix of displays, the displays may initially show indication in the form of coordinates, such as “A1”, “A2”, “A3”, “B1”, “B2”, “B3”, “C1”, etc.

1. A signage system comprising a plurality of textile products, wherein each textile product comprises a flexible display device adapted to show a display content forming part of a unified message, each flexible display device being adapted to show an indication of the position of the display content of the flexible display device in relation to the display contents of the other flexible display devices in the unified message, before showing said display content.

2. A system according to claim 1, wherein said indication is an indication of an element of a sequential order, and wherein for each flexible display device said element's position in the sequential order corresponds to the position of the flexible display device's display content in the unified messaged.

3. A system according to claim 2, wherein said element is a character or number of a sequential order of characters or numbers.

4. A system according to claim 1, wherein at least one of the textile products further comprises an alert mechanism adapted to be actuated during the showing of said indication to alert a wearer of the textile product of said showing of said indication.

5. A system according to claim 1, wherein said textile product is a garment, such as a shirt.

6. A system according to claim 1, wherein said flexible display device is an LED based display.

7. (canceled)
